(19) United States
(12) Patent Application Publication
(10) Pub. No.: US 2021/0027439 A1
(43) Pub. Date: Jan. 28, 2021

(54) ORIENTATION ADJUSTMENT OF OBJECTS IN IMAGES

(71) Applicant: QUALCOMM Incorporated, San Diego, CA (US)

(72) Inventor: Pia ZOBEL, Hinanit (IL)

(21) Appl. No.: 16/518,258

(22) Filed: Jul. 22, 2019

(51) Int. Cl. G06T 5/50; G06T 7/70; G06T 7/174

(52) U.S. Cl. CPC G06T 5/50; G06T 2207/20221; G06T 7/174; G06T 7/70

(57) ABSTRACT

Aspects of the present disclosure relate to systems and methods for adjusting an orientation in an image. A device may include one or more processors coupled to a memory. The one or more processors may be configured to receive a first frame captured by a first camera from a first perspective. The first frame includes a first depiction of an object with a first orientation. The one or more processors also may be configured to receive a second frame captured by a second camera from a second perspective. The first frame and the second frame are captured concurrently, and the second frame includes a second depiction of the object with a second orientation. The one or more processors are further configured to determine a final orientation of the object based on the first orientation and the second orientation, and generate a final image depicting the object with the final orientation.

### TECHNICAL FIELD

This disclosure relates generally to image capture systems and devices, including adjusting the orientation of one or more objects in an image.

### BACKGROUND OF RELATED ART

A camera may be used to capture multiple objects in an image. For example, a photographer may use his or her camera to capture a group picture of multiple people. In another example, a photographer may use his or her camera to capture a desired object (such as a sculpture, painting, person, face, etc.) framed in a desired background (such as a desired landscape, museum, etc.). In capturing images or video, an object may not have a desired orientation during capture. For example, a person may turn his or her head when posing for a picture, and as a result, the person's head may not be facing the camera in the resulting image. In another example, the orientation of the background may differ from the orientation of the object.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Aspects of the present disclosure relate to systems and methods for adjusting an orientation in an image. An example device may include one or more processors coupled to a memory. The one or more processors may be configured to receive a first frame captured by a first camera from a first perspective. The first frame includes a first depiction of an object with a first orientation. The one or more processors also may be configured to receive a second frame captured by a second camera from a second perspective. The first frame and the second frame are captured concurrently, and the second frame includes a second depiction of the object with a second orientation. The one or more processors are further configured to determine a final orientation of the object based on the first orientation and the second orientation, and generate a final image depicting the object with the final orientation.

An example method includes receiving, by one or more processors, a first frame captured by a first camera from a first perspective. The first frame includes a first depiction of an object with a first orientation. The method also includes receiving, by the one or more processors, a second frame captured by a second camera from a second perspective. The first frame and the second frame are captured concurrently, and the second frame includes a second depiction of the object with a second orientation. The method further includes determining, by the one or more processors, a final orientation of the object based on the first orientation and the second orientation, and generating a final image depicting the object with the final orientation.

In a further example, a non-transitory computer-readable medium is disclosed. The non-transitory computer-readable medium may store instructions that, when executed by one or more processors, cause a device to receive a first frame captured by a first camera from a first perspective. The first frame includes a first depiction of an object with a first orientation. Execution of the instructions may further cause the device to receive a second frame captured by a second camera from a second perspective. The first frame and the second frame are captured concurrently, and the second frame includes a second depiction of the object with a second orientation. Execution of the instructions may further cause the device to determine a final orientation of the object based on the first orientation and the second orientation, and generate a final image depicting the object with the final orientation.

In another example, a device is disclosed. The device includes means for receiving a first frame captured by a first camera from a first perspective. The first frame includes a first depiction of an object with a first orientation. The device further includes means for receiving a second frame captured by a second camera from a second perspective. The first frame and the second frame are captured concurrently, and the second frame includes a second depiction of the object with a second orientation. The device also includes means for determining a final orientation of the object based on the first orientation and the second orientation, and means for generating a final image depicting the object with the final orientation.

### BRIEF DESCRIPTION OF THE DRAWINGS

Aspects of the present disclosure are illustrated by way of example, and not by way of limitation, in the figures of the accompanying drawings and in which like reference numerals refer to similar elements.

FIG. 1A is a depiction of an example camera capturing frames of a scene from a first perspective.

FIG. 1B is a depiction of an example frame captured by the camera in FIG. 1A.

FIG. 2A is a depiction of an example camera capturing frames of the scene from FIG. 1A from a second perspective.

FIG. 2B is a depiction of an example frame captured by the camera in FIG. 2A.

FIG. 3A is a depiction of an example camera capturing frames of a scene from a first perspective.

FIG. 3B is a depiction of an example camera capturing frames of the scene from FIG. 3A from a second perspective.

FIG. 4 is a block diagram of an example device for adjusting the orientation of one or more objects for a final image.

FIG. 5 is a depiction of a first camera and a second camera concurrently capturing frames of a scene.

FIG. 6 is a depiction of generating a final image from a first frame captured by a first camera and from a second frame captured by a second camera.

FIG. 7 is an illustrative flow chart depicting an example operation for generating a final image including a depiction of an object with a determined orientation.

FIG. 8 is an illustrative flow chart depicting an example operation for selecting a final orientation of an object for a final image.

FIG. 9 is a depiction of artifacts to be corrected for a final image when combining a first frame and a second frame.

FIG. 10 is a depiction of correcting artifacts for a final image.

### DETAILED DESCRIPTION

Aspects of the present disclosure may be used for determining or adjusting the orientation of one or more objects in a final image.

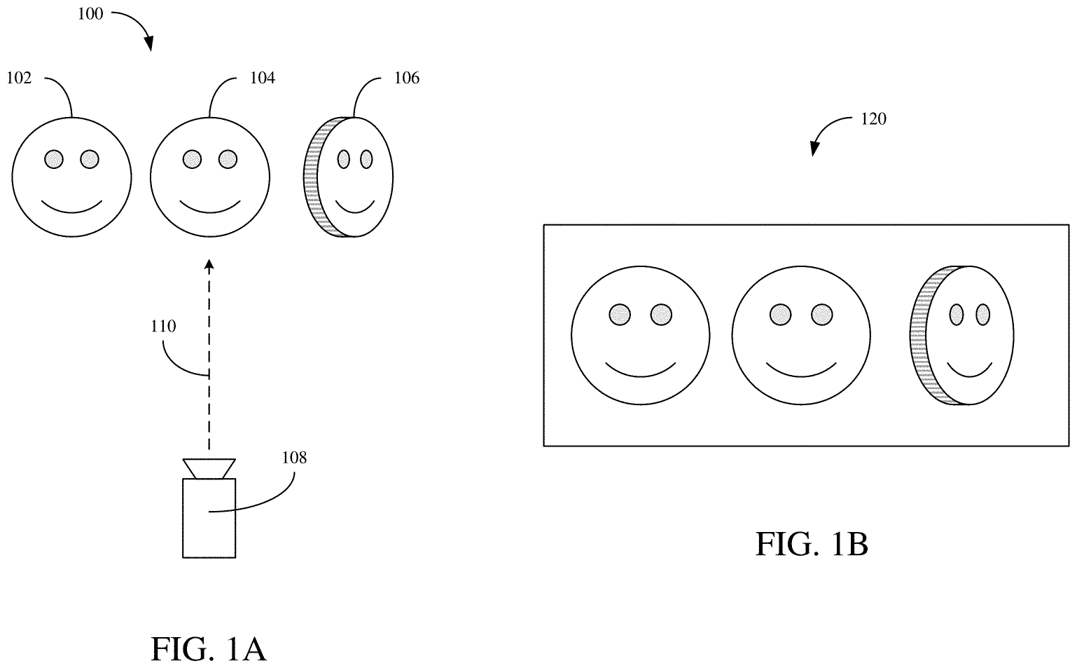

Referring to FIG. 1A, a camera may be positioned at a first perspective to capture frames of multiple objects, such as people, sculptures, vehicles, etc. FIG. 1A is a depiction of an example camera 108 at a first perspective (illustrated by the direction of capture 110) capturing frames of a scene 100 including persons 102, 104, and 106. As shown, person 102 and person 104 (or the faces) or oriented toward the camera 108, and person 106 (or the face) may be oriented away from the camera 108. For example, person 106 may look away from the camera 108 or otherwise be oriented away from the camera 108. As a result, a captured frame from the camera 108 includes depictions of the person 102 and person 104 oriented toward the camera 108 and a depiction of the person 106 oriented away from the camera 108.

FIG. 1B is a depiction of an example frame 120 captured by the camera 108 (FIG. 1A). As depicted in the frame 120, persons 102 and 104 (FIG. 1A) are oriented toward a person viewing the frame 120, but person 106 (FIG. 1A) is oriented away from the person. As a result, all people in the frame 120 do not have a desired orientation.

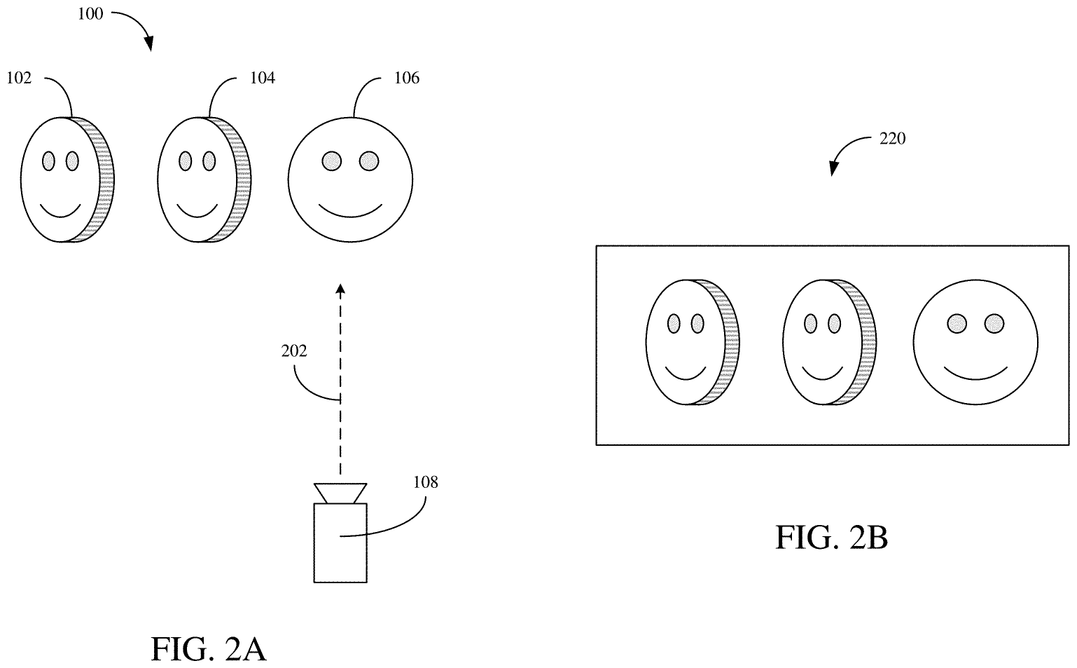

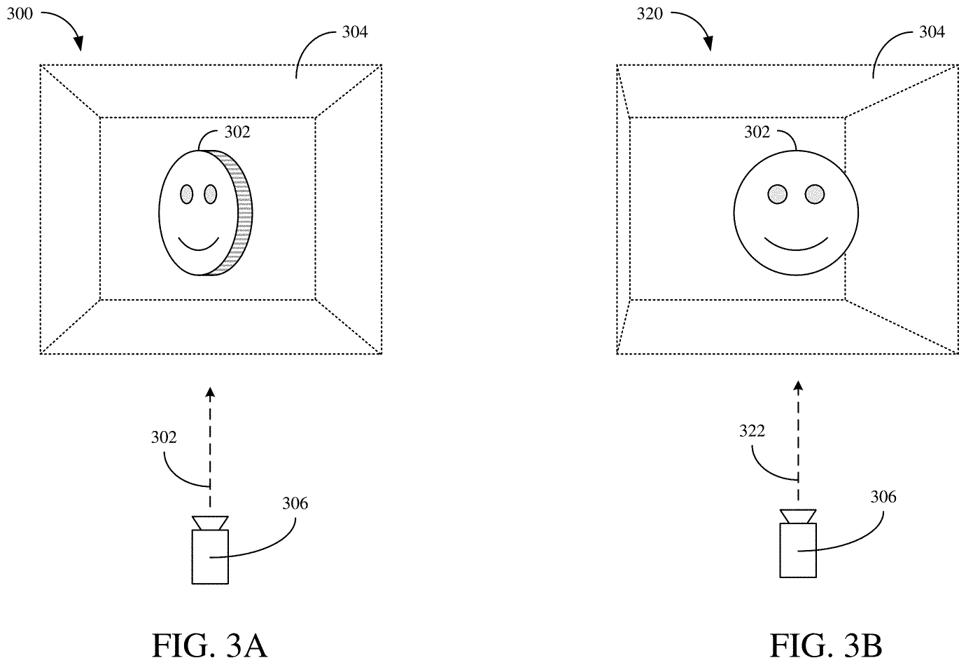

The perspective of the camera 108 may be moved in light of the orientation of person 106. FIG. 2A is a depiction of the camera 108 capturing frames of the scene 100 (FIG. 1A) from a second perspective (illustrated by the direction of capture 202). FIG. 2B is a depiction of an example frame 220 captured by the camera 108 (FIG. 2A). As depicted in the frame 220, persons 102 and 104 (FIG. 2A) are oriented away from a person viewing the frame 120, but person 106 (FIG. 2A) is oriented toward the person. Similar to the frame 120 in FIG. 1B, all people in the frame 220 do not have a desired orientation.

A device may attempt to adjust an orientation of an object (such as the person 106) by using a sequence of frames over time. For example, a camera may capture multiple frames over, e.g., 5 seconds, and a frame with a preferred orientation of an object may be selected from the multiple frames. A portion of the selected frame may be combined with another frame of the sequence of frames in generating a final image (such as a final group portrait of persons 102, 104, and 106).

One problem with using a sequence of frames from one camera is that local motion in the scene may cause artifacts in a final image. For example, changes in shadows, birds or other objects moving through the scene may cause blurring or multiple visions of objects in a final image. Another problem is that global motion during the time for capturing the sequence of frames may cause artifacts in a final image. For example, a user may hold a camera, and the user's hands may shake, or the user may sway, causing the camera to move during captures. The global motion may cause blurring or double vision of objects in a final image. A further problem is the amount of time required in capturing the sequence of images. If a camera requires 5 seconds to capture a sequence of frames, people or other animate objects in the scene are required to remain relatively still for the period of time. Children, e.g., may not be able to remain still for such a period of time, and therefore a final image may be undesirable. Another problem is that the orientations of people (or objects) not oriented toward the camera may not change during the period of time for capturing the sequence of frames, and no frame in the sequence may include a desired orientation of the one or more persons or objects.

While FIGS. 1A-2B illustrate people (or other objects) in the foreground as having different orientations, an object (in the foreground) and the background may have different orientations. A camera may capture the desired object (such as a sculpture, painting, person, face, etc.) framed in a desired background (such as a desired landscape, museum, etc.). For example, a person may stand between a row of columns, inside a door frame, etc. for an image capture. However, the row of columns, the door frame, etc. may not have a desired orientation with respect to the object's orientation. A person holding the camera may move the camera to different perspectives to change the orientations of the background and the person during capture of a sequence of frames. However, the above problems described with using a sequence of images also apply.

In some implementations, two or more cameras from different perspectives may capture frames concurrently. For example, a smartphone or other suitable device may include two or more cameras spaced apart from one another and configured to capture frames concurrently. The device may then combine portions of the concurrently captured frames to include the desired orientation of each object (such as two people, a person and a background, etc.) in the scene in generating a final image. Since the frames are captured concurrently from different perspectives, problems regarding local motion, global motion, etc. may be reduced.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure. Some portions of the detailed descriptions which follow are presented in terms of procedures, logic blocks, processing and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory and the like.

Aspects of the present disclosure are applicable to any suitable electronic device capable of capturing images or video (such as security systems, smartphones, tablets, laptop computers, digital video and/or still cameras, web cameras, and so on with two or more cameras or camera sensors). While described below with respect to a device having or coupled to two cameras, aspects of the present disclosure are applicable to devices having any number of cameras (including no cameras, where a separate device is used for capturing images or video which are provided to the device, or three or more cameras for capturing multiple associated image frames), and are therefore not limited to devices having two cameras. Aspects of the present disclosure are applicable for capturing still images as well as for capturing video, and may be implemented in devices having or coupled to cameras of different capabilities (such as a video camera or a still image camera).

The term “device” is not limited to one or a specific number of physical objects (such as one smartphone, one camera controller, one processing system and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects.

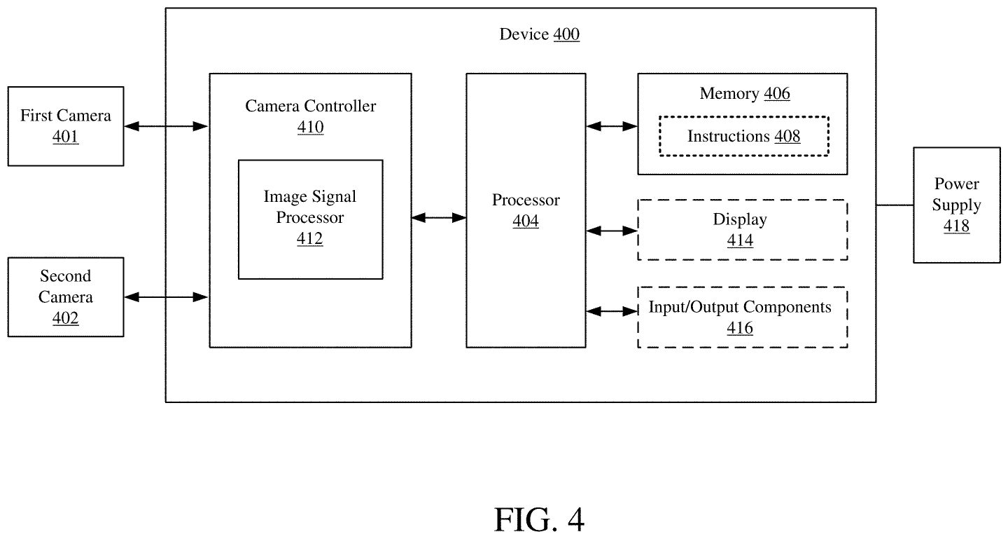

FIG. 4 is a block diagram of an example device 400 for adjusting orientations of depictions of one or more objects in a final image. The example device 400 may include or be coupled to a first camera 401, a second camera 402, a processor 404, a memory 406 storing instructions 408, and a camera controller 410. The device 400 may optionally include (or be coupled to) a display 414 and a number of input/output (I/O) components 416. The device 400 may include additional features or components not shown. For example, a wireless interface, which may include a number of transceivers and a baseband processor, may be included for a wireless communication device. The device 400 may include or be coupled to additional cameras other than the first camera 401 and the second camera 402. The disclosure is not to be limited to any specific examples or illustrations, including the example device 400.

The first camera 401 and the second camera 402 may be capable of capturing individual image frames (such as still images) and/or capturing video (such as a succession of captured image frames) of a scene from different perspectives. For example, the first camera 401 may be positioned along a first edge or a first location on a side of the device 400 (such as the back of a smartphone), and the second camera 402 may be positioned along an opposite edge or a second location on the same side of the device 400. The first location of the first camera 401 is associated with a first perspective for capturing frames, and the second location of the second camera 402 is associated with a second perspective associated with capturing frames.

In one example, the first camera 401 and the second camera 402 may be part of a multiple (e.g., dual) camera module. In another example, while the first camera 401 and the second camera 402 have an overlapping field of view (FOV), the first camera 401 and the second camera 402 may be part of a multiple camera system for stitching, stacking, or comparing image frames of a scene (such as frozen moment visual effects or for increasing a field of view or depth of field). In some implementations, the first camera 401 may be a primary camera, and the second camera 402 may be an auxiliary camera. Each camera may include a single camera sensor, or themselves be a dual camera module or any other suitable module with multiple camera sensors, with one or more sensors being used for capturing image frames. Additionally, the capabilities of each camera may be the same or different.

The memory 406 may be a non-transient or non-transitory computer readable medium storing computer-executable instructions 408 to perform all or a portion of one or more operations described in this disclosure. The device 400 may also include a power supply 418, which may be coupled to or integrated into the device 400.

The processor 404 may be one or more suitable processors capable of executing scripts or instructions of one or more software programs (such as instructions 408) stored within the memory 406. For example, the processor 404 may execute an imaging application requiring image frames from the first camera 401 and the second camera 402 (such as combining frames between the two cameras 401 and 402). In some aspects, the processor 404 may be one or more general purpose processors that execute instructions 408 to cause the device 400 to perform any number of functions or operations. In additional or alternative aspects, the processor 404 may include integrated circuits or other hardware to perform functions or operations without the use of software.

While shown to be coupled to each other via the processor 404 in the example of FIG. 4, the processor 404, the memory 406, the camera controller 410, the optional display 414, and the optional I/O components 416 may be coupled to one another in various arrangements. For example, the processor 404, the memory 406, the camera controller 410, the optional display 414, and/or the optional I/O components 416 may be coupled to each other via one or more local buses (not shown for simplicity).

The display 414 may be any suitable display or screen allowing for user interaction and/or to present items (such as captured images, video, or preview images from the multiple cameras) for viewing by a user. In some aspects, the display 414 may be a touch-sensitive display. The I/O components 416 may be or include any suitable mechanism, interface, or device to receive input (such as commands) from the user and to provide output to the user. For example, the I/O components 416 may include (but are not limited to) a graphical user interface, keyboard, mouse, microphone and speakers, and so on.

The camera controller 410 may include an image signal processor 412, which may be one or more image signal processors to process captured image frames or video provided by the first camera 401 and the second camera 402. For example, the camera controller 410 (such as the image signal processor 412) may adjust the orientation of an object depiction in a final, processed image, including segmenting and combining frames from the first camera 401 and the second camera 402. In some example implementations, the camera controller 410 (such as the image signal processor 412) may also control operation of the first camera 401 and the second camera 402. For example, the camera controller 410 (such as the image signal processor 412) may adjust or instruct the cameras 401 and 402 to adjust one or more camera settings or configurations (such as the focal length, ISO setting, flash, resolution, capture or frame rate, etc.).

In some aspects, the image signal processor 412 may execute instructions from a memory (such as instructions 408 from the memory 406 or instructions stored in a separate memory coupled to the image signal processor 412) to process image frames or video captured by the first camera 401 and the second camera 402. In other aspects, the image signal processor 412 may include specific hardware to process image frames or video captured by the first camera 401 and the second camera 402. The image signal processor 412 may alternatively or additionally include a combination of specific hardware and the ability to execute software instructions.

In some implementations, the device 400 may use the first camera 401 and the second camera 402 to concurrently capture frames of a scene from different perspectives. As a result, objects in the scene (such as people, background, etc.) are depicted with different orientations in associated frames from the cameras. The device 400 may be configured to generate a final image based on the frames with depictions of objects with different orientations. For example, the device 400 may combine portions of the associated frames so that depictions of the objects have a desired orientation in a final image. Herein, the term “image” may mean a monoscopic image.

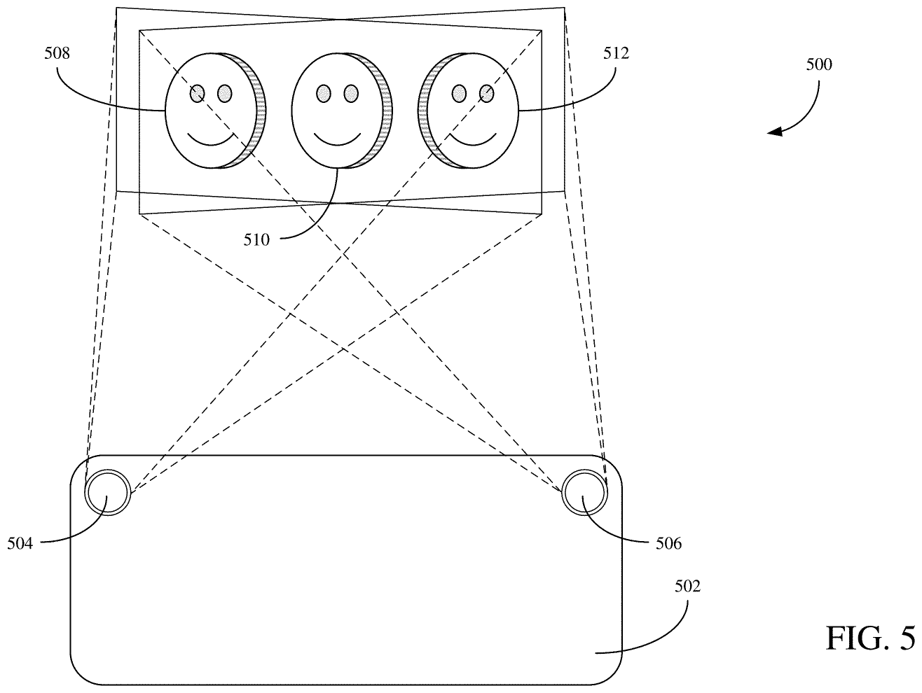

FIG. 5 is a depiction 500 of a first camera 504 and a second camera 506 of a device 502 concurrently capturing frames of a scene. As shown, the scene includes person 508, person 510, and person 512. The orientations of person 508 and person 510 are more toward the first camera 504, and the orientation of person 512 is more toward the second camera 506. In some examples, depictions of the person 508 and person 510 in the frame captured by the first camera 504, and a depiction of the person 512 in the frame captured by the second camera 506, may be used for a final image. For example, portions of the captured frames depicting the objects with the desired orientations may be combined to generate a final image.

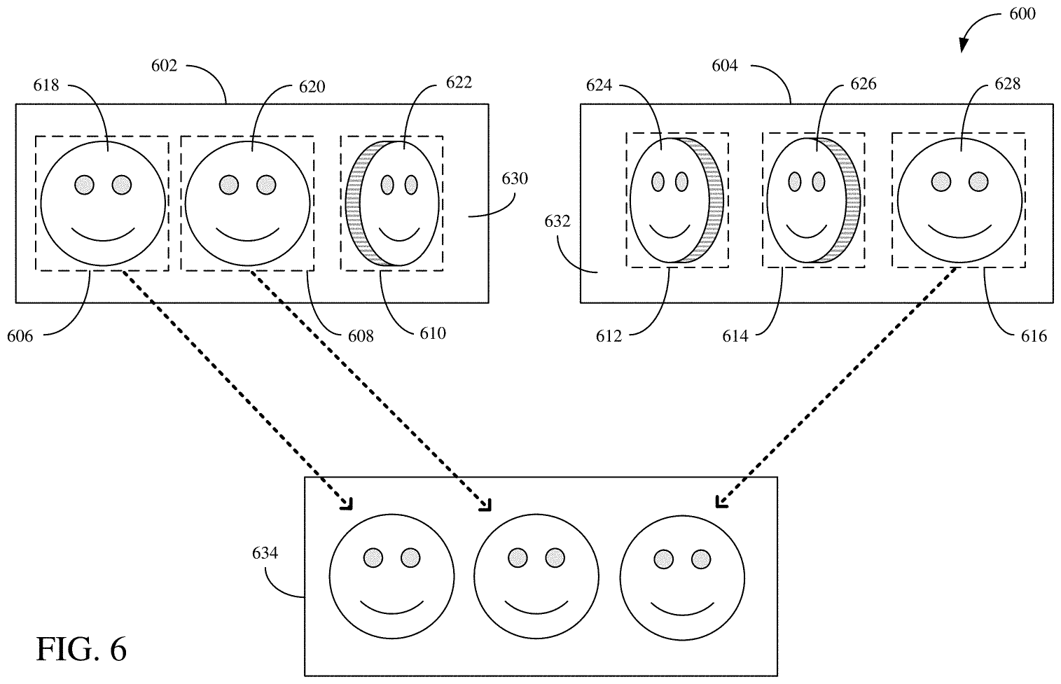

FIG. 6 is a depiction 600 of generating a final image 634 from a first frame 602 captured by a first camera and from a second frame 604 captured by a second camera. Frame 602 may be an example frame captured by the first camera 504 (FIG. 5), and frame 604 may be an example frame concurrently captured by the second camera 506 (FIG. 5). In the example, the first frame 602 includes depictions 618, 620, and 622 of persons 508, 510, and 512, respectively, in the scene in FIG. 5. The second frame 604 includes depictions 624, 626, and 628 of persons 508, 510, and 512, respectively, in the scene in FIG. 5.

As illustrated, depiction 618 in the first frame 602 and depiction 624 in the second frame 604 include different orientations for person 508. Similarly, depiction 620 in the first frame 602 and depiction 626 in the second frame 604 include different orientations for person 510, and depiction 622 in the first frame 602 and depiction 628 in the second frame 604 include different orientations for person 512. Person 508 and person 510 are oriented toward the first camera 504 in FIG. 5. As a result, the first frame 602 may include depiction 618 and depiction 620 with the preferred orientation of persons 508 and 510, respectively (as compared to depictions 624 and 626). However, person 512 is oriented toward the second camera 506 in FIG. 5. As a result, the second frame 604 may include depiction 628 with the preferred orientation of person 512 (as compared to depiction 622).

In some implementations of generating a final image 634, the device 400 (such as the device 502 in FIG. 5), may combine one or more portions of the first frame 602 with one or more portions of the second frame 604. In one example, the device 400 may segment a portion of the first frame 602 including the depiction 618. An example segmentation may be a cropping, generating another layer including the segment, generating the segment as another image, or other suitable means for segmenting frames. In the first frame 602, the example segmentation 606 is depicted as a dashed box. For example, the device 400 may determine a suitable size and dimensions of a box for the segment 606 to include the depiction 618. The device 400 may also segment other depictions in the first frame 602 and the second frame 604 (such as depictions 620-628 associated with segments 608-616, respectively).

Boxes or rectangles depicting the region of a frame to be segmented is only for illustrative purposes, as any suitable segmentation may be used. For example, other suitable defined shapes (such as diamonds, ovals, triangles, etc.) may be used for segmentation. In another example, the device 400 may determine the pixels of the frame associated with the depiction to be segmented. For example, the device 400 may determine if changes in neighboring pixel values (such as luminance, color, focus, etc.) indicates the end of a depiction for segmentation in the frame. Additionally or alternatively, the device 400 may determine edges in the frame (such as by performing a Hough transform or other edge detection processes) to determine where segmentation for the depiction is to end. The device 400 may also include a portion of the background or border of pixels around a depiction to be included in the segment. In some example implementations, facial detection may be used to determine an initial portion for segmentation, and the device 400 may determine a final portion for segmentation to include the body, the bust, accessories, or other portion of the person outside of the face.

The device 400 may also use any suitable means for determining which objects depicted in associated frames are to have their orientations in the frames compared or adjusted for generating a final image. In some aspects, the device 400 may automatically determine possible objects of interest depicted in the captured frames. For example, the device 400 may use facial detection to detect faces in the captured frames. The device 400 may also associate depictions of faces between frames based on, e.g., the location of the depictions in the respective frames, facial recognition indicating the faces are the same person between frames, etc. Regarding associating depictions between frames based on the locations of the depictions in the frames, the distance and positioning between the first camera 401 and the second camera 402 may be known. Based on the known positioning and distance of the cameras, the device 400 may associate regions of frames captured by the first camera 401 with respective regions of frames captured by the second camera 402. For example, the device 400 may include a mapping or correlation of pixels or groups of pixels between a first camera's image sensor and a second camera's image sensor, and the mapping may be used by the device 400 to associate depictions or segments of captured frames with one another.

In some other implementations, automatically determining potential objects of interest may be based on the location of the object(s) in the field of view (FOV) of the cameras 401 and 402. For example, an object in the center of the FOVs may be an object of interest, while an object on the periphery of the FOV may not be an object of interest. The probability of being an object of interest may be a function related to the distance of the object from the center of the FOV.

In some further implementations, automatically determining potential objects of interest may be based on object recognition. For example, the device 400 may use suitable object recognition techniques to determine a relative, a family pet or other known object is in the FOVs of the first camera 401 and the second camera 402. The device 400 may thus identify the person, pet, etc. as potential objects of interest. Any other suitable means for automatically identifying objects of interest may be used, though, and the present disclosure is not limited to the provided examples.

In addition or alternative to the device 400 automatically determining the objects of interest for adjusting the orientations of their depictions in a final image, the device 400 may receive user input indicating the objects of interest. For example, the device may display a preview on a touch sensitive display 414, and the user may touch the portions of the display 414 to indicate the objects of interest. Combining automatically determining objects of interest and receiving user input regarding the objects of interest, the device 400 may determine potential objects of interest (e.g., facial detection, object recognition, location in FOV of the cameras, etc.) and the user may select additional objects of interest and/or deselect any of the potential objects of interest. In this manner, the device 400 determines the final objects of interest. The device 400 may therefore compare the segments between associated frames for the objects of interest to determine the desired orientation of each object.

Referring back to FIG. 6, the objects of interest are the persons depicted in the first frame 602 and the second frame 604. The device 400 may segment the depictions 618-628 into segments 606-616, respectively. The segment with the preferred orientation for each object may be included in the final image 634. For example, segment 606 and segment 608 from the first frame 602 may be included in the final image 634, and segment 616 from the second frame 604 may be included in the final image 634.

In some implementations, the device 400 may segment a background in the frames (such as background 630 in the first frame 602 and background 632 in the second frame 604). The final image 634 may include one of the backgrounds 630 and 632 or a combination of the backgrounds 630 and 632. In some implementations, if the first camera 401 that captures the first frame 602 is a primary camera of the device 400, the device 400 may use the background 630 for the final image 634. In some other implementations, the device 400 may determine the background to use for the final image 634 based on an image quality metric between the frames 602 and 604 or between the backgrounds 630 and 632.

In some further implementations, the device 400 may determine which frame includes, e.g., the most segments to be included in the final image, the largest area based on the segments to be included in the final image, etc. to determine which background is to be included in the final image 634. In this manner, regions or borders for blending between segments during processing (e.g., gamma correction, correcting luminance, correcting color variance, etc.) may be reduced to generate the final image 634.

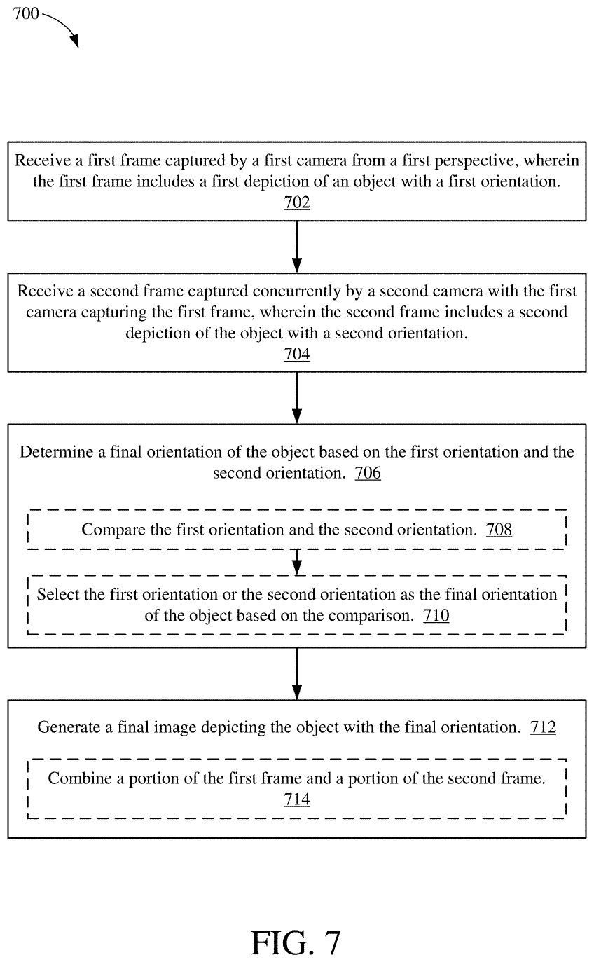

FIG. 7 is an illustrative flow chart depicting an example operation 700 for generating a final image including a depiction of an object with a determined orientation. Operation 700 may be an example process for generating the final image 634 from the first frame 602 and the second frame 604 in FIG. 6. Beginning at 702, the device 400 receives a first frame captured by a first camera 401 from a first perspective. In some implementations, the first camera 401 may capture the first frame, and the camera controller 410 (such as the image signal processor 412) may receive the first frame captured by the first camera 401. The first frame includes a first depiction of the object of interest with a first orientation. For example, the first frame may include a depiction of a person, a face, a background, or other suitable object whose orientation may be adjusted during processing from the first frame to a final image.

The device 400 also receives a second frame captured by a second camera 402 from a second perspective (704). The second frame is captured by the second camera 402 concurrently with the first frame being captured by the first camera 401. The camera controller 410 (such as the image signal processor 412) may receive the second frame captured by the second camera 402, and the second frame includes a second depiction of the object of interest with a second orientation (based on the difference in perspectives between the cameras 401 and 402).

After receiving the first frame and the second frame, the device 400 may determine a final orientation of the object based on the first orientation of the object depicted in the first frame and the second orientation of the object depicted in the second frame (706). The final orientation is the orientation of the depiction of the object in the final image. For example, the final orientation of the person 508 in the final image 634 (FIGS. 5 and 6) is the orientation of the person 508 in depiction 618.

In some implementations, the device 400 may compare the first orientation and the second orientation of the object (708). For example, the device 400 (such as the image signal processor 412 or the processor 404) may compare the associated depictions of the object between frames to determine the depiction with the preferred orientation. In one example, the device 400 may compare segmented portions including the associated depictions to determine the final orientation.

In some implementations, after comparing the first orientation and the second orientation, the device 400 may select the first orientation or the second orientation as the final orientation of the object based on the comparison (710). In some aspects, the device 400 may automatically determine the final orientation. For example, the device 400 may determine which depiction includes an orientation of the object more toward the camera as compared to the other depiction. To illustrate, the device 400 may compare segments 606 and 612 including depictions 618 and 624 (FIG. 6). The device 400 may determine that the depiction 618 includes an orientation of the object more towards the first camera 401 than the depiction 624 of the object toward the second camera 402 (the face is shown as turned away from the second camera 402 during capture of the second frame 604).

Additionally or alternatively, a user may select the preferred orientation of an object for the final image. For example, the device 400 may display the segment 606 and the segment 612 side by side on a touch sensitive display 414. The user may then touch the displayed segment including the preferred orientation of the object, and the selected segment may be included in the final image 634. In some implementations, the device 400 may automatically select the orientation in some cases, and the user may select the orientation in other cases. For example, if one or more orientations of an object in associated segments cannot be determined by the device 400, the device 400 may request the user to select the preferred orientation.

The device 400 may then generate a final image depicting the object with the final orientation (712). In some implementations, the device 400 may combine a portion of the first frame and a portion of the second frame to generate the final image (714). For example, the depiction 628 in the second frame 604 may have the final orientation of the person 512. The device 400 may combine the segment 616 from the second frame 604 with the background 630 from the first frame 602 to generate the final image 634. In some implementations, the segment 616 may be laid as a second layer over the first frame 602 (as a first layer of an image) to cover segment 610. The device 400 may then merge the layers to generate the final image 634. Other suitable techniques of combining the portions of the frames may be performed, and the present disclosure is not limited to a specific example.

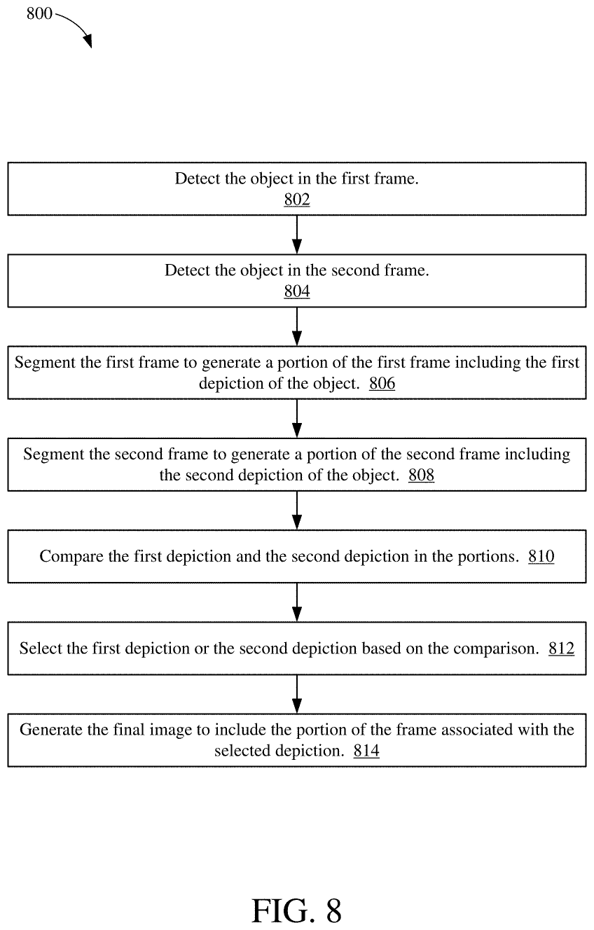

FIG. 8 is an illustrative flow chart depicting an example operation 800 for selecting a final orientation of an object for a final image. Operation 800 may be an example implementation of steps 706 and 712 in FIG. 7. After receiving the associated frames that are concurrently captured (and including depictions of the object of interest), the device 400 may detect the object in the first frame (802) and may detect the object in the second frame (804). Any suitable means for detecting the object may be used (such as the example methods described herein), including automatic detection by the device 400 or detection based on a user input.

The device 400 may then segment the first frame to generate a portion of the first frame including the first depiction of the object (806), and the device 400 may segment the second frame to generate a portion of the second frame including the second depiction of the object (808). Any suitable means for segmentation may be used (such as using the example segmentation shapes and methods described herein), including automatic segmentation by the device 400 or segmentation based on a user input.

The device 400 may then compare the first depiction and the second depiction in the segmented portions (810), and the device may select the first depiction of the second depiction based on the comparison (812). For example, the device 400 may compare associated segments between a first frame and a second frame to determine a preferred orientation of the object for a final image. In some implementations, the device 400 may compare an image quality or other metrics for the segments in addition to the orientation of the object. For example, if the object appears out of focus or is obstructed in one depiction, the device 400 may prevent including the associated segment in the final image. In this manner, the device 400 may preserve an image quality of a final image.

The device 400 may then generate the final image to include the portion of the frame associated with the selected depiction (814). For example, the device 400 may select a first orientation of an object depicted in a first frame. The device 400 may then combine the associated segment of the first frame with a portion of the second frame (such as a segmented background) to generate the final image.

In some implementations, the device 400 may be configured to switch between an automatic mode and an assistive mode. In an automatic mode, the device 400 may automatically identify the final objects of interest, segment the objects of interest, determine the final orientation of each object of interest, and generate the final image. In an assistive mode, the device 400 may request a user input regarding identifying objects, segmenting (such as drawing boxes or borders around a depiction in a frame), and/or determining the final orientation (such as selecting the preferred orientation from associated segments including depictions of the object).

There exists a parallax between associated frames (captured by the first camera 401 and captured by the second camera 402 of the device 400) as a result of the distance between the cameras. Additionally, the focal length may differ between the cameras 401 and 402 (such as if one camera includes a wide-angle lens and the other camera includes a telephoto lens). Additionally or alternatively, manufacturing aspects of the device 400, lens imperfections, or other camera components or processing techniques may cause an inherent pan, tilt, or roll between the first camera 401 and the second camera 402. As a result, a depiction of an object in a first frame captured by the first camera 401 may be at a different location than the depiction of the object in a second frame captured by the second camera 402. The associated depictions between frames may also be a different size and/or distorted (such as stretched, tilted, etc.) with respect to one another.

Therefore, combining portions of a first frame and a second frame may cause artifacts in generating a final image. For example, a depiction in a segment from a second frame may be of an incorrect size, proportions, or location with respect to a first frame. As a result, the segment from the second frame combined into the first frame may cause a portion of pixels in the combined image to not have values from the first frame or the second frame, or have incorrect values from the first frame or the second frame.

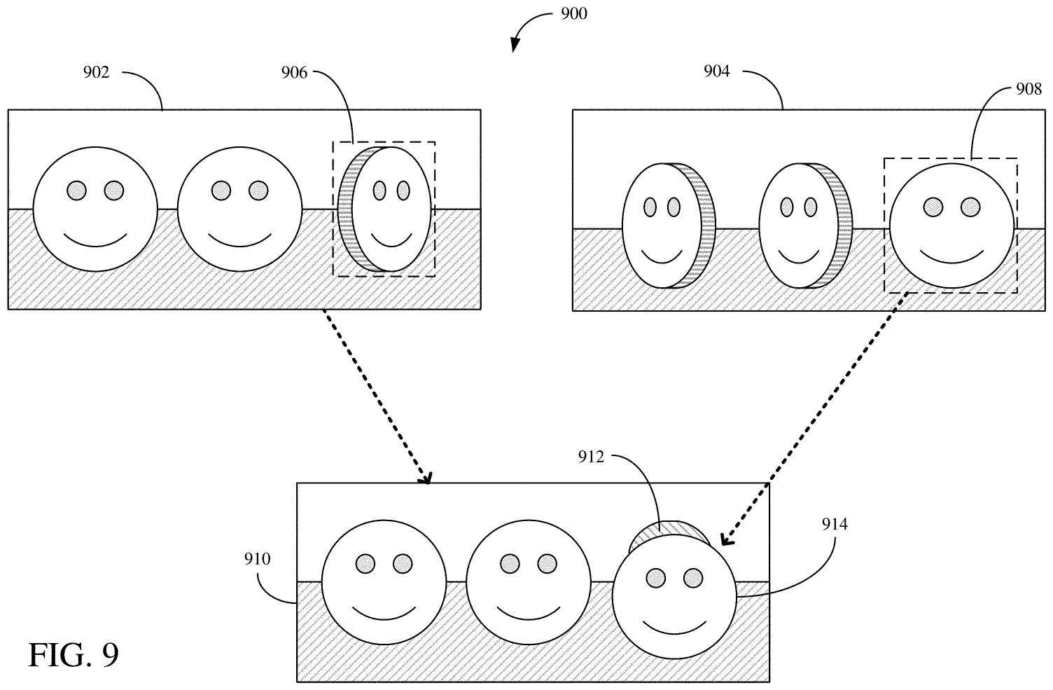

FIG. 9 is a depiction 900 of example artifacts to be corrected for a final image when combining one or more portions of a first frame 902 and a second frame 904 in generating a final image. When combining portion 908 of the second frame 904 and the portion of the first frame 902 outside portion 906, portion 908 may not perfectly align with portion 906 to replace portion 906 for a final image. For example, the second camera 402 capturing the second frame 904 may be higher from the ground than the first camera 401 capturing the first frame 902. As a result, depictions of the persons in the first frame 902 are higher than in the second frame 904. Additionally, the orientation of the person depicted in segments 906 and 908 may be oriented more toward the second camera 402 than the first camera 401.

As a result, the location and number of pixels differ for the depiction of the person between frames 902 and 904. For example, if portions of the frames are combined without adjusting the depiction 914 from the segment 908 (as illustrated by combined image 910), the depiction 914 does not cover the entire area of the first frame 902 including the depiction of the person (illustrated by region 912). Additionally, the depiction 914 is lower than the other depictions in the combined image 910. While not illustrated, other artifacts may include differences in size or dimensions of the depictions, parallax artifacts, distortions in a depiction as a result of manufacturing or camera components, differences in resolution, differences in focal range, etc.

The device 400 may use any suitable techniques for correcting artifacts for generating a final image. For example, the depiction 914 may be moved vertically in the image 910. The device 400 may then fill in pixels for the background or other portions of the image 910 not corresponding to the depiction 914.

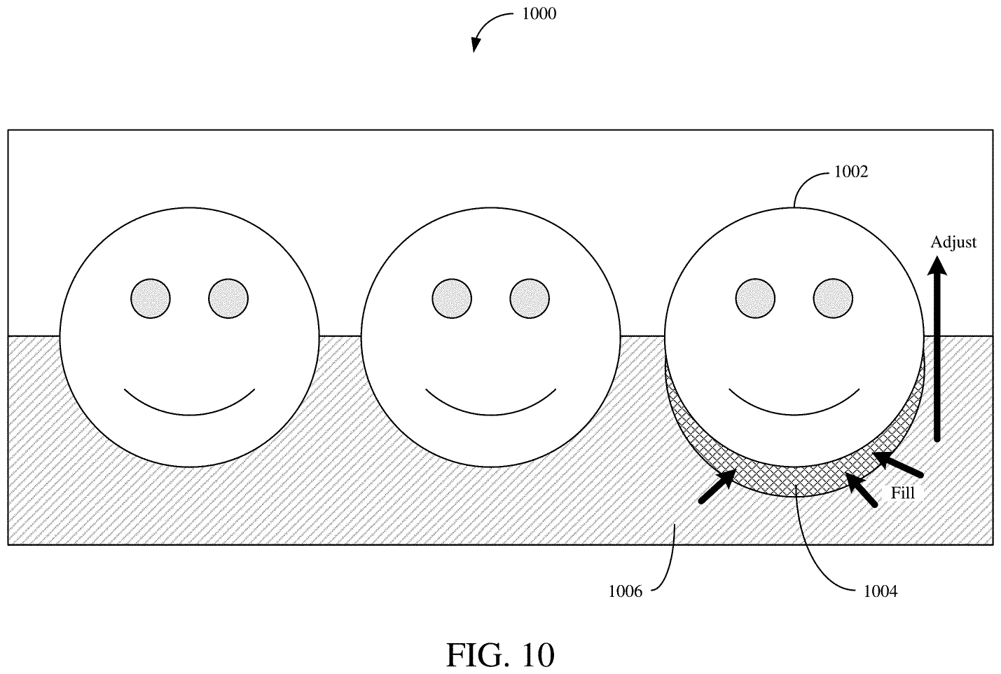

FIG. 10 is a depiction 1000 of correcting artifacts for a final image. In some examples, the depiction 1000 may correspond to the image 910 in FIG. 9. The depiction 1002 may be from a second frame captured by the second camera 402, and the remainder may be from a first frame captured by the first camera 401. To generate a final image, the device 400 may adjust the position of the depiction 1002 in the image. In some implementations of adjusting the position, the device 400 may align a center position of the depiction 1002 with a center position of the associated depiction in the first frame. In some other implementations, the device 400 may compare the backgrounds surrounding the associated depictions to position the depiction 1002 in the first frame. While not shown, the device 400 may also stretch, skew, roll, tilt, slant, or otherwise modify the depiction 1002 for the depiction 1002 to be combined with portions of the first frame.

When the position (or other features) of the depiction 1002 is adjusted, region 1004 vacated by the depiction 1002 may not include pixel data or may include incorrect pixel data. For example, the portion of the first frame corresponding to the region 1004 may include pixel data regarding the object depicted in depiction 1002 that is being replaced. In another example, moving the depiction 1002 may leave a blank space (null pixel data) in the image.

The device 400 may fill the region 1004. For example, the device may use neighboring pixel data from the background 1006 to fill in region 1004. In another example, the device 400 may use pixel data from the first frame and corresponding to the location of region 1004 to fill in region 1004. However, any suitable method for filling and/or blending of pixel data in regions such as region 1004 may be performed, and the present disclosure is not limited to a specific example.

In combining portions of different frames to generate a final image, the device 400 may perform any suitable processing technique to increase the image quality of an image. For example, the device 400 may ensure a consistent color balance, consistent luminance, continuous edges, consistent focus, consistent gamma, etc. in generating the final image (such as performing edge enhancement filters, blurring filters, noise reduction filters, etc., in generating a final image). After generating the final image, the device 400 may store the final image (such as in a memory 406), may provide the final image to another device, may display the final image, or perform any other suitable operation.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium (such as the memory 406 in the example device 400 of FIG. 4) comprising instructions 408 that, when executed by the processor 404 (or the camera controller 410 or the image signal processor 412), cause the device 400 to perform one or more of the methods described above. The non-transitory processor-readable data storage medium may form part of a computer program product, which may include packaging materials.

For example, associated frames may be processed by the image signal processor 412 after capture by the first camera 401 and the second camera 402. Methods of adjusting the orientation in a final image may be embodied in an application stored in the memory 406 and to be executed by the processor 404, which may be an applications processor. In this manner, the processor 404 may process the processed image frames from the image signal processor 412 to generate a final image with an adjusted orientation for an object. In another example, the operations may be performed by the image signal processor 412 during processing of associated frames. In a further example, portions of the processes may be performed by different components of the device 400 and/or at different times.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as the processor 404 or the image signal processor 412 in the example device 400 of FIG. 4. Such processor(s) may include but are not limited to one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

While the present disclosure shows illustrative aspects, it should be noted that various changes and modifications could be made herein without departing from the scope of the appended claims. For example, while the techniques are described with respect to device 400, any suitable device may perform the techniques described herein. For example, a processing system separate from the cameras may receive previously captured frames for processing. As such, the present disclosure is not limited to a specific device configuration for performing aspects of the disclosure.

Additionally, the functions, steps or actions of the method claims in accordance with aspects described herein need not be performed in any particular order unless expressly stated otherwise. For example, the steps of the described example operations, if performed by the device 400, the camera controller 410, the processor 404, and/or the image signal processor 412, may be performed in any order and at any frequency. For example, identification of objects and segmentation of the objects may be performed in any order for different objects and across frames.

Furthermore, although elements may be described or claimed in the singular, the plural is contemplated unless limitation to the singular is explicitly stated. For example, while two image frames captured by two cameras are described, any number of cameras and image frames may be used. Additionally, streams of image frames from multiple cameras may be used (combining orientation adjustment of an object using both comparison of depictions from sequential frames and comparison of depictions from concurrently captured frames). Additionally, while persons or faces are illustrated to describe various orientation adjustment techniques, the techniques apply for any suitable object in a scene, including animate and in animate objects, as well as adjusting the orientation of a background for an object in the foreground.

Accordingly, the disclosure is not limited to the illustrated examples and any means for performing the functionality described herein are included in aspects of the disclosure.

What is claimed is:

1. A device configured to adjust an orientation in an image, comprising:
a memory; and
one or more processors implemented in circuitry, coupled to the memory, and configured to:
receive a first frame captured by a first camera from a first perspective, wherein the first frame includes a first depiction of an object with a first orientation;
receive a second frame captured by a second camera from a second perspective, wherein the first frame and the second frame are captured concurrently and wherein the second frame includes a second depiction of the object with a second orientation;
determine a final orientation of the object based on the first orientation and the second orientation; and
generate a final image depicting the object with the final orientation.

2. The device of claim 1, wherein the one or more processors, in determining the final orientation of the object, are configured to:
select the first orientation as the final orientation of the object.

3. The device of claim 2, wherein the one or more processors, in generating the final image, are configured to:
combine a first portion of the first frame including the first depiction of the object and a first portion of the second frame not including the second depiction of the object.

4. The device of claim 3, wherein the one or more processors are further configured to:
segment the first frame to generate the first portion of the first frame;
segment the second frame to generate a second portion of the second frame including the second depiction of the object; and
compare the first portion of the first frame and the second portion of the second frame, wherein selecting the first orientation as the final orientation is based on the comparison.

5. The device of claim 4, wherein the one or more processors are configured to:
detect the object in the first frame, wherein segmenting the first frame to generate the first portion of the first frame is based on detecting the object in the first frame; and
detect the object in the second frame, wherein segmenting the second frame to generate the second portion of the second frame is based on detecting the object in the second frame.

6. The device of claim 4, wherein the first portion of the second frame includes a background of the object.

7. The device of claim 6, wherein the one or more processors, in generating the final image, are further configured to:
adjust the first portion of the first frame to be combined with the first portion of the second frame; and
fill a portion of the final image not including the first portion of the first frame and not including the first portion of the second frame, wherein filling the portion of the final frame is based on the first portion of the second frame.

8. The device of claim 1, further comprising:
the first camera configured to capture the first frame; and
the second camera configured to capture the second frame concurrently with the first camera capturing the first frame.

9. A method to adjust an orientation in an image, comprising:
receiving, by one or more processors, a first frame captured by a first camera from a first perspective, wherein the first frame includes a first depiction of an object with a first orientation;
receiving, by the one or more processors, a second frame captured by a second camera from a second perspective, wherein the first frame and the second frame are captured concurrently and wherein the second frame includes a second depiction of the object with a second orientation;
determining, by the one or more processors, a final orientation of the object based on the first orientation and the second orientation; and
generating a final image depicting the object with the final orientation.

10. The method of claim 9, wherein determining the final orientation of the object comprises:
selecting the first orientation as the final orientation of the object.

11. The method of claim 10, wherein generating the final image comprises:
combining a first portion of the first frame including the first depiction of the object and a first portion of the second frame not including the second depiction of the object.

12. The method of claim 11, further comprising:
segmenting the first frame to generate the first portion of the first frame;
segmenting the second frame to generate a second portion of the second frame including the second depiction of the object; and
comparing the first portion of the first frame and the second portion of the second frame, wherein selecting the first orientation as the final orientation is based on the comparison.

13. The method of claim 12, further comprising:
detecting the object in the first frame, wherein segmenting the first frame to generate the first portion of the first frame is based on detecting the object in the first frame; and
detecting the object in the second frame, wherein segmenting the second frame to generate the second portion of the second frame is based on detecting the object in the second frame.

14. The method of claim 12, wherein the first portion of the second frame includes a background of the object.

15. The method of claim 14, wherein generating the final image further comprises:
adjusting the first portion of the first frame to be combined with the first portion of the second frame; and
filling a portion of the final image not including the first portion of the first frame and not including the first portion of the second frame, wherein filling the portion of the final frame is based on the first portion of the second frame.

16. The method of claim 9, further comprising:
capturing, by the first camera, the first frame; and
capturing, by the second camera, the second frame concurrently with the first camera capturing the first frame.

17. A non-transitory computer-readable medium storing one or more programs containing instructions that, when executed by one or more processors of a device, cause the device to:
receive a first frame captured by a first camera from a first perspective, wherein the first frame includes a first depiction of an object with a first orientation;
receive a second frame captured by a second camera from a second perspective, wherein the first frame and the second frame are captured concurrently and wherein the second frame includes a second depiction of the object with a second orientation;
determine a final orientation of the object based on the first orientation and the second orientation; and
generate a final image depicting the object with the final orientation.

18. The computer-readable medium of claim 17, wherein execution of the instructions for determining the final orientation of the object causes the device to:
select the first orientation as the final orientation of the object.

19. The computer-readable medium of claim 18, wherein execution of the instructions for generating the final image causes the device to:
combine a first portion of the first frame including the first depiction of the object and a first portion of the second frame not including the second depiction of the object.

20. The computer-readable medium of claim 19, wherein execution of the instructions further causes the device to:
segment the first frame to generate the first portion of the first frame;
segment the second frame to generate a second portion of the second frame including the second depiction of the object; and
compare the first portion of the first frame and the second portion of the second frame, wherein selecting the first orientation as the final orientation is based on the comparison.

21. The computer-readable medium of claim 20, wherein the first portion of the second frame includes a background of the object.

22. The computer-readable medium of claim 21, wherein execution of the instructions for generating the final image further causes the device to:
adjust the first portion of the first frame to be combined with the first portion of the second frame; and
fill a portion of the final image not including the first portion of the first frame and not including the first portion of the second frame, wherein filling the portion of the final frame is based on the first portion of the second frame.

23. The computer-readable medium of claim 17, wherein execution of the instructions further causes the device to:
capture the first frame; and
capture the second frame concurrently with capturing the first frame.

24. A device configured to adjust an orientation in an image, comprising:
means for receiving a first frame captured by a first camera from a first perspective, wherein the first frame includes a first depiction of an object with a first orientation;
means for receiving a second frame captured by a second camera from a second perspective, wherein the first frame and the second frame are captured concurrently and wherein the second frame includes a second depiction of the object with a second orientation;
means for determining a final orientation of the object based on the first orientation and the second orientation; and
means for generating a final image depicting the object with the final orientation.

25. The device of claim 24, wherein the means for determining the final orientation of the object comprise means for selecting the first orientation as the final orientation of the object.

26. The device of claim 25, wherein the means for generating the final image comprise means for combining a first portion of the first frame including the first depiction of the object and a first portion of the second frame not including the second depiction of the object.

27. The device of claim 26, further comprising:
means for segmenting the first frame to generate the first portion of the first frame;
means for segmenting the second frame to generate a second portion of the second frame including the second depiction of the object; and
means for comparing the first portion of the first frame and the second portion of the second frame, wherein selecting the first orientation as the final orientation is based on the comparison.

28. The device of claim 27, further comprising:
means for detecting the object in the first frame, wherein segmenting the first frame to generate the first portion of the first frame is based on detecting the object in the first frame; and
means for detecting the object in the second frame, wherein segmenting the second frame to generate the second portion of the second frame is based on detecting the object in the second frame.

29. The device of claim 27, wherein the first portion of the second frame includes a background of the object.

30. The device of claim 29, wherein the means for generating the final image further comprise:
means for adjusting the first portion of the first frame to be combined with the first portion of the second frame; and
means for filling a portion of the final image not including the first portion of the first frame and not including the first portion of the second frame, wherein filling the portion of the final frame is based on the first portion of the second frame.
